(19) United States
(12) Patent Application Publication
(10) Pub. No.: US 2023/0288142 A1
(43) Pub. Date: Sep. 14, 2023

(54) Batchwise-Charged Electric Arc Furnace System

(71) Applicant: AMI INTERNATIONAL SAPI DE C.V, Monterrey (MX)

(72) Inventor: Mariana Viale, Monterrey (MX)

(21) Appl. No.: 18/120,139

(22) Filed: Mar. 10, 2023

Related U.S. Application Data
(60) Provisional application No. 63/318,505, filed on Mar. 10, 2022.

(51) Int. Cl. F27D 3/00; F27B 3/08; F27B 3/18; G06V 10/764; G06T 7/62; G06V 10/80

(52) U.S. Cl. CPC F27D 3/0027; F27B 3/085; F27B 3/18; G06V 10/764; G06T 7/62; G06V 10/803; F27D 2021/0042

(57) ABSTRACT

Methods and systems for determining a respective mass associated with respective portions of the respective layers of metallic scrap material deposited into a charging-bucket associated with a batchwise-charged electric arc furnace (EAF) are provided, in which the methods and systems determine the respective masses associated with the respective portions of the respective layers of metallic scrap material based on (a) the respective volume of the respective portions of the respective layers of metallic scrap material and (b) the respective assigned densities assigned by a machine learning classification model based on digital images of the respective portions of the respective layers of metallic scrap material.

### CROSS-REFERENCE TO RELATED APPLICATIONS

This application claims priority under 35 U.S.C. § 119 to U.S. Patent Application No. 63/318,505 filed Mar. 10, 2022, which is expressly incorporated by reference herein in its entirety.

### TECHNICAL FIELD

Embodiments of the presently-disclosed invention relate generally to methods and systems of determining a respective mass associated with respective portions of respective layers of metallic scrap material deposited into a charging-bucket(s) associated with a batchwise-charged electric arc furnace (EAF), as well as methods and systems related to operating a batchwise-charged EAF system.

### BACKGROUND

The traditional method of steel production is based on a blast furnace (BOF) route in which iron ore is reduced and molten in a blast furnace using coke before refining in BOF converter. The coke burns and produces energy and the iron ore is reduced due to its reactions with carbon and carbon monoxide. However, in the last few years the Electric Arc Furnace (EAF) steel making process is rapidly gaining interest over the BOF technology worldwide.

Among the advantages of the EAF process, next to lower emissions, flexibility is an argument on behalf of EAFs. This process is extremely flexible compared with the BOF route, which cannot be turned on and off at will in accordance with current market situation. The tendency towards more advanced, flexible, and cleaner processes calls for technology which can be quickly implemented and adapted to the specific needs of each steel producer.

Batchwise-charged EAFs are currently the most common way to recycle steel from metallic scrap material (e.g., steel scrap). There is a broad variety of steel scrap, both in terms of composition and geometry. By melting the steel scrap in a furnace with the help of electrodes and an electrical current, new, functional steel can be produced from old products. Instead of deploying raw material resources, basic steel elements and valuable alloys can be reused, which is beneficial from both economic and environmental point of view.

Depending on the grade of steel being produced the scrap mix composition (e.g., mixture of different types or classes of steel scrap charged into the EAF) should fulfill certain chemical composition ranges or targets. Usually, a schedule is developed prior to each production shift and a scrap yard operator will prepare charging-buckets of steel scrap according to the needs of the production program. As such, preparation of the charging-bucket is an important operation, not only to ensure proper melt chemistry but also to ensure good melting conditions within the EAF. The metallic scrap material must be layered in the charging-bucket according to respective size and density to promote the rapid formation of a liquid pool of steel in the hearth of the EAF while providing protection to the sidewalls and roof of the hearth from electric arc radiation. Other considerations include minimization of metallic scrap material cave-ins inside the EAF, which can break electrodes, and ensuring that large heavy pieces of metallic scrap material do not lie directly in from of burner ports which would result in blow-back of the flame onto water-cooled panels. In some instances, the batchwise charge of metallic scrap material may also include lime and carbon, or these can be injected into the EAF during the heat. In this regard, the EAF operates as a batch melting process producing batches of steel known as “heats”.

Accordingly, there remains a need in the batchwise-charged EAF art for a reliable method and/or system for determining a batch profile (e.g., mass, volume, chemical composition, etc.) for a batchwise-charged EAF, which may facilitate safe and efficient operation of the batchwise-charged EAF.

### SUMMARY OF INVENTION

Certain embodiments according to the invention provide a method for determining a batch profile for a batchwise-charged electric arc furnace (EAF) including one or more charging-buckets. In accordance with certain embodiments of the invention, the method may comprise the following steps: (i) obtaining respective red-green-blue (RGB) digital images of respective portions of respective layers (e.g., one or more separate layers stacked upon one another) of metallic scrap material deposited into a first charging-bucket; (ii) generating respective depth images via camera stereo vision of the respective portions of the respective layers of metallic scrap material in a computer processor, wherein one or more pixels of the respective depth images are correlated to respective 3D coordinates of the respective portions of respective layers of metallic scrap material in the computer processor; (iii) determining respective volumes of the respective portions of the respective layers of metallic scrap material in the computer processer based on at least a portion of the respective 3D coordinates of the respective portions of the respective layers of metallic scrap material; (v) identifying respective classifications of the respective portions of the respective layers of metallic scrap material from a group of known metallic scrap materials based on at least a respective portion of the respective RGB digital images via a machine learning model in the computer processor, and assigning a respective density to the respective portions of the respective layers of metallic scrap material; and (vi) determining a respective mass associated with respective portions of the respective layers of metallic scrap material based on (a) the respective volume of the respective portions of the respective layers of metallic scrap material and (b) the respective assigned density.

In another aspect, certain embodiments according to the invention provide a method of operating a batchwise-charged electric arc furnace (EAF) including one or more charging-buckets. The method may comprise determining an actual batch profile defined by metallic scrap material housed within one more charging-buckets. The step of determining the actual batch profile may comprise a step of (i) determining a respective mass associated with respective portions of the respective layers of metallic scrap material based on (a) the respective volume of the respective portions of the respective layers of metallic scrap material and (b) the respective assigned density as described and disclosed herein; and/or (ii) determining an aggregate mass of metallic scrap material within a one or more charging-buckets as described and disclosed herein, and/or an aggregate volume of metallic scrap material within the one or more charging-buckets as described and disclosed herein, and/or (iii) determining an aggregate chemical composition of the metallic scrap material within the one or more charging-buckets as described and disclosed herein. The method may further comprise comparing the actual batch profile with an operating state and/or an operating set point of the EAF in a computer processor and modifying an the operating state and/or the operating set point based on the actual batch profile.

In another aspect, certain embodiments according to the invention provide a system for determining a batch profile for a batchwise-charged electric arc furnace (EAF) including one or more charging-buckets. The system may include a sensor fusion module including two monochrome cameras configured to provide stereo vision, a RGB camera, an infrared spectrum projector, and a first computer processor in operative communication with the two monochrome cameras, the RGB camera, and the infrared spectrum projector. The first computer processor may be configured to (a) generate respective depth images via stereo and correlate one or more pixels of the respective depth images to respective 3D coordinates of the respective portions of respective layers of metallic scrap material, and (c) determine respective volumes of the respective portions of the respective layers of metallic scrap material based on at least a portion of the respective 3D coordinates of the respective portions of the respective layers of metallic scrap material. The system may also include a scrap classifier module in operative communication with the sensor fusion module and comprising a machine learning model and a second computer processor. The second computer processor may be configured to (a) identify respective classifications of the respective portions of the respective layers of metallic scrap material from a group of known metallic scrap materials based on at least a respective portion of the respective RGB digital images received from the sensor fusion module, (b) assign a respective density to the respective portions of the respective layers of metallic scrap material, and (c) determine a respective mass associated with respective portions of the respective layers of metallic scrap material based on (a) the respective volume of the respective portions of the respective layers of metallic scrap material and (b) the respective assigned density.

In yet another aspect, certain embodiments according to the invention provide an electric arc furnace (EAF) system. The system may include an EAF including a furnace body defining an interior portion and a set of electrodes extending into the interior portion. The system may also include one or more charging-buckets. In accordance with certain embodiments of the invention, the system may include a sensor fusion module mounted above and proximate to the one or more charging-buckets, the sensor fusion module including two monochrome cameras configured to provide stereo vision, a RGB camera, an infrared spectrum projector, and a first computer processor in operative communication with the two monochrome cameras, the RGB camera, and the infrared spectrum projector. The first computer processor may be configured to (a) generate respective depth images via stereo and correlate one or more pixels of the respective depth images to respective 3D coordinates of the respective portions of respective layers of metallic scrap material, and (c) determine respective volumes of the respective portions of the respective layers of metallic scrap material based on at least a portion of the respective 3D coordinates of the respective portions of the respective layers of metallic scrap material. The system may also comprise a scrap classifier module in operative communication with the sensor fusion module and comprising a machine learning model and a second computer processor configured to (a) identify respective classifications of the respective portions of the respective layers of metallic scrap material from a group of known metallic scrap materials based on at least a respective portion of the respective RGB digital images received from the sensor fusion module, (b) assign a respective density to the respective portions of the respective layers of metallic scrap material, and (c) determine a respective mass associated with respective portions of the respective layers of metallic scrap material based on (a) the respective volume of the respective portions of the respective layers of metallic scrap material and (b) the respective assigned density.

### BRIEF DESCRIPTION OF THE DRAWING(S)

The invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout, and wherein:

FIG. 1 illustrates a scrap bay layout for and EAF system in accordance with certain embodiments of the invention;

FIG. 2A is an image of scrap bins housing different types or classes of metallic scrap material in accordance with certain embodiments of the invention;

FIG. 2B is another image of scrap bins housing different types or classes of metallic scrap material in accordance with certain embodiments of the invention;

FIG. 2C is another image of scrap bins housing different types or classes of metallic scrap material in accordance with certain embodiments of the invention;

FIG. 2D is another image of scrap bins housing different types or classes of metallic scrap material in accordance with certain embodiments of the invention;

FIG. 3 illustrates a charging-bucket housing a plurality of layers of different types or classes of metallic scrap material in accordance with certain embodiments of the invention;

FIG. 4 illustrates a charging-bucket housing a plurality of layers of different types or classes of metallic scrap material including an oversized piece of scrap material that may be detected and result in the triggering of an alarm in accordance with certain embodiments of the invention;

FIG. 5 illustrates a three (3) bucket charge schedule accounting for a batch for charging into an EAF in accordance with certain embodiments of the invention;

FIG. 6 illustrates a three-dimensional (3D) or depth camera that may be used in accordance with certain embodiments of the invention;

FIG. 7 shows a depth image generated by stereo vision on the left side and a corresponding RGB digital image on the right side;

FIG. 8 illustrates a system functionality flow chart in accordance with certain embodiments of the invention;

FIG. 9 illustrates a schematic of a system for operating an EAF system in accordance with certain embodiments of the invention.

### DETAILED DESCRIPTION

Embodiments of the invention now will be described more fully hereinafter with reference to the accompanying drawings, in which some, but not all embodiments of the invention are shown. Indeed, the present invention may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise. As used herein, the term “and/or” includes any and all combinations of one or more of the associated listed items.

Embodiments of the present invention relate generally to methods and systems that measure and/or determine the mass, volume, and/or chemical composition of a metallic scrap material housed within one or more charging-buckets, in which the metallic scrap material may comprise a one or more layers of one or more layers of different types or classes of metallic scrap materials. In this regard, a single or each charging-bucket may include a layered mix of multiple types or classes of metallic scrap material based on a proposed charging schedule. In this regard, the methods and systems in accordance with certain embodiments of the invention may measure and/or determine the mass, volume, and/or chemical composition of each and every individual layer of metallic scrap material disposed within one or more charging-buckets. Consequently, an aggregate (e.g., a scrap mix) mass, volume, and/or chemical composition for each charging-bucket may be determined in accordance with certain embodiments of the invention. Additionally or alternatively, the methods and systems may determine an actual batch profile defined by metallic scrap material housed within the one more charging-buckets. That is, the aggregate (e.g., a scrap mix) mass, volume, and/or chemical composition for each charging-bucket may be determined and used to determine an overall batch profile (e.g., the mass, volume, and/or average chemical composition across all charging-buckets) for operation of an EAF.

The actual batch profile (weather comprised of only one charging-bucket or several charging-buckets), as determined in accordance with certain methods and systems described and disclosed herein, may be integrated with existing programmable logic controls (PLC) associated with operation of the EAF to provide an accurate tap weight (e.g., weight of molten steel exiting the EAF) estimation and an optimized energy usage (e.g., electrical current consumed by the electrodes of the EAF). In accordance with certain embodiments of the invention, the methods and systems may determine a real time volume of the metallic scrap material in one or more charging-buckets, such as by using stereo vision to generate a depth image (e.g., by comparing relative pixel locations between two digital image taken from two vantage points, three-dimensional information can be extracted by examining the relative positions of objects or pixels in in the two digital images) from which the volume of the metallic scrap material (e.g., for each layer) may be determined in a computer processor. The methods and systems, for example, may also comprise obtaining a RGB digital images of the metallic scrap material and processing the RGB through a machine learning model, which may have been previously trained and validated by a machine learning operation, configured to identify and/or classify the nature of the particular metallic scrap material of each layer disposed within the one or more charging-buckets. That is, the metallic scrap material disposed within the one or more charging buckets may include a plurality of different types or classes of metallic scrap material (e.g., different chemical compositions, different geometries, etc.). Table 1, for example, illustrates a non-exhaustive summary of some common classes of metallic scrap materials along with their respective chemical compositions, bulk density, and form.

TABLE 1

| Known | | | | |
|---|---|---|---|---|
| Metallic | | Bulk | | |
| Scrap | Average Composition/ | Density/ | | Cost/ |
| Material | wt-% | kg m⁻³ | Form* | tonne |
| Non Heavy | 0.025% C, 0.017% Si, 0.025% P, | 0.85 | CS | $160 |
| | 0.033% S, 0.2% Cr, 0.15% Ni, | | | |
| | 0.03% Mo + Fe bal. | | | |
| Nog Heavy | 0.03% C, 0.022% Si, 0.028% P, | 0.75 | CS | $140 |
| | 0.035% S, 0.26% Si, 0.18% Ni, | | | |
| | 0.03% Mo + Fe bal. | | | |
| Internal | 0.17% C, 0.04% Si, 0.31% Mn, | 3.0 | CS | $240 |
| Low | 0.013% P, 0.0014% S, 0.26% Cr, | | | |
| Alloyed | 0.4% Ni, 0.001% Nb, 0.015% Ti, | | | |
| | 0.005% V, 0.14% Mo + Fe bal. | | | |
| Plate and | 0.25% C, 0.25% Si, 1.0% Mn, | 2.0 | CS | $290 |
| Structural | 0.025% P, 0.025% S, 0.15% Cr, | | | |
| | 0.05% Mo, 0.15% Ni, 0.22% Sn | | | |
| Internal | 0.015% C, 0.33% Si, 1.64% Mn, | 3.0 | CS | $330 |
| Stainless | 0.014% P, 0.002% S, 18.32% Cr, | | | |
| Steel | 8.08% Ni, 0.01% Nb, 0.004% Ti, | | | |
| | 0.01% V, 1.3% Mo, 0.16% N + Fe | | | |
| | bal. | | | |
| No₁ | 0.027% C, 0.012% Si, 0.12% Mn, | 1.2 | FS | $180 |
| Bundles | 0.01% P, 0.006% S, 0.032% Cr, | | | |
| | 0.02% Ni, 0.001% Ti + Fe bal. | | | |
| No₂ | 0.04% C, 0.016% Si, 0.12% Mn, | 1.1 | FS | $170 |
| Bundles | 0.014% P, 0.008% S, 0.04% Cr, | | | |
| | 0.03% Ni, 0.0014% Ti + Fe bal. | | | |
| Direct | 2.4% C, 0.1% P, 0.01% S, 0.02% Ti, | 1.65 | FS | $220 |
| Reduced | 0.03% Nb, 0.02% + Fe bal. | | | |
| Iron (DRI) | | | | |
| Shredded | 0.03% C, 0.015% Si, 0.02% P, | 1.5 | VFS | $200 |
| | 0.03% S, 0.12% Cr, 0.1% Ni, | | | |
| | 0.02% Mo + Fe bal. | | | |
| No₁ | 0.03% C, 0.01% Si, 0.02% P, | 1.5 | VFS | $210 |
| Busheling | 0.02% S, 0.08% Cr, 0.06% Ni, | | | |
| | 0.01% Mo + Fe bal. | | | |

*CS = Coarse Scrap,
FS = Fine Scrap,
VFS = Very fine Scrap

The machine learning model, for example, may identify the particular class or classes of metallic scrap material in each layer based on at least a portion of the RGB digital image of each layer in real time. For example, a respective RGB digital images (e.g., frame) of a particular layer may be obtained after being deposited in a charging-bucket may obtained by the RGB camera and processed in real time by the machine learning model to identify when a first portion of the metallic scrap material comprising a first type or class of metallic scrap material has been freshly deposited over the top a previously deposited layer of a second portion of the metallic scrap material comprising a second type or class of metallic scrap material. Based on the identification of the type or class of metallic scrap material, a scrap density may be assigned to each component or piece of the metallic scrap material of each layer of metallic scrap material disposed inside a charging-bin. In accordance with certain embodiments of the invention, respective assigned scrap densities along with respective volume values of the metallic scrap material (whether in one or more layers of the same or different types or classes of metallic scrap material) may be utilized in real time to determine an actual batch profile for charging into an EAF.

In accordance with certain embodiments of the invention, the methods and systems described and disclosed herein may provide one or more alarms or warnings, such as in real time. For example, the machine learning model may further be configured to identify when undesirable and/or dangerous materials (e.g., materials that are undesirable in the EAF during operation thereof), such as oil or containers that are or may be housing undesirable liquids (e.g., such as one or more oils, based on a RGB digital image. In this regard, the identification of the undesirable and/or dangerous materials may be provided to a computer processer that is configured to trigger and alarm or warning to operators that an undesirable and/or dangerous material is present within the metallic scrap material, such that the operators have an opportunity to remove the undesirable and/or dangerous material prior to being undesirably being charged into the EAF. Additionally or alternatively, the methods and systems may include a computer processor configured to trigger an alarm or warning upon identification of a piece of the metallic scrap material as having a volume above a size threshold and/or an orientation extending outside of a predetermined working zone, in which such identification may be based on the volume determination and/or depth image. If such an over-sized piece of metallic scrap material where to be charged to the EAF, the act of charging the over-sized piece of metallic scrap material may strike or otherwise damage the electrodes extending into the hearth section of the EAF. The identification and alarm triggering of the presence of such an over-sized piece of metallic scrap material enables the operator to either remove this over-sized piece or at least partially retract the electrode from the hearth of the EAF to prevent damaging the electrodes.

Additionally or alternatively, the methods and systems may include a computer processor configured trigger an alarm or warning when a volume of the metallic scrap material present in the one or more charging-buckets is determined to exceed the available volume of the EAF. In this regard, the identification and alarm triggering of such volume-challenged scenario prevents undesirable conditions in which the volume of metallic scrap material charged into the EAF exceeds the available volume of the EAF, such as to a degree in which the top of the EAF may not be closed and/or sealed. The identification and/or triggering of an alarm in such scenarios enables an operator to proactively manipulate or control the charging method to the EAF (e.g., revising the order in which charging-buckets are charged, partial charging of a particular charging-bucket, etc.).

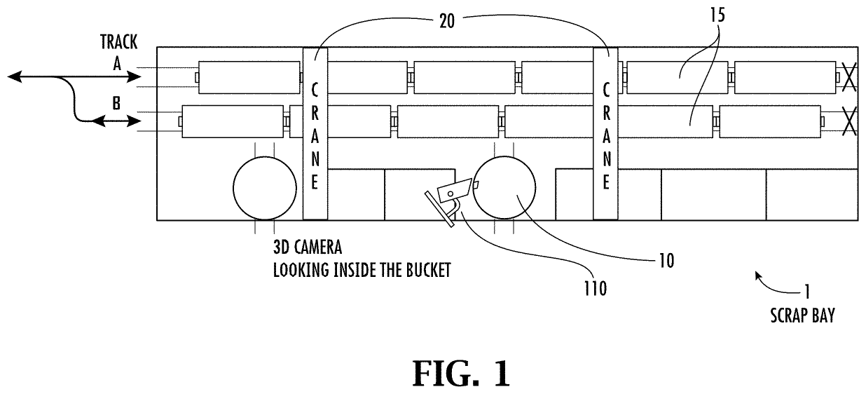

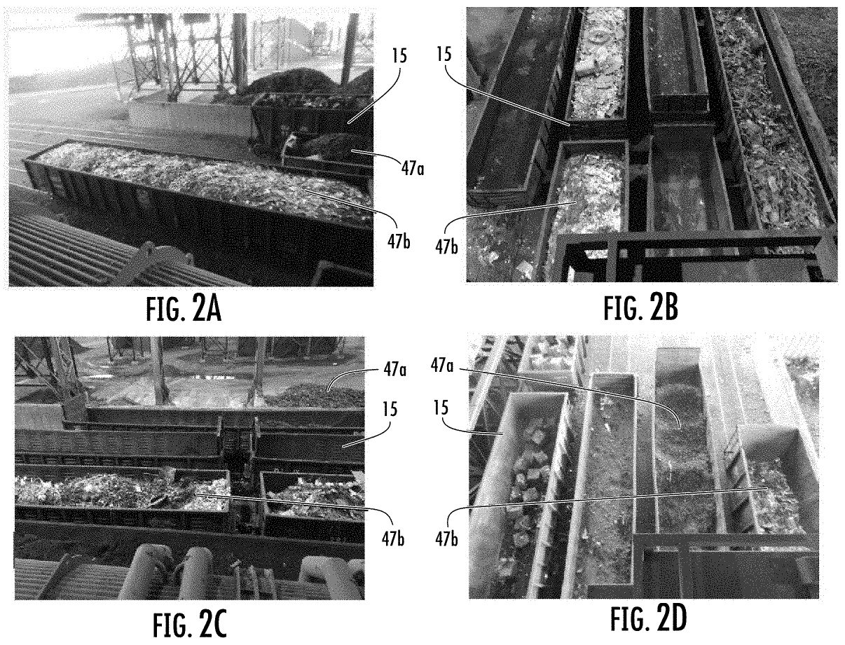

FIG. 1 illustrates an example scrap yard layout for a batchwise-charged EAF. As shown in FIG. 1, the scrapyard may include a plurality of charging-buckets 10, storage bins 15 (or rail cars), and cranes 20. In this regard, storage bins 15 may each contain metallic scrap material as illustrated in FIGS. 2A-D. As shown in FIGS. 2A-D, for example, the metallic scrap material 47 may include at least a first type or class 47a and a second type or class 47b of metallic scrap material. In this regard, the crane 20 may move portions of a wide variety of different types or classes of metallic scrap material from one or more storage bins 15 into one or more charging-buckets 20 to assemble a charging-batch to be charged into a batchwise-charge EAF. FIG. 1 also illustrates the mounting of a 3D or depth camera above and proximate to at least one charging-bucket 10. In this regard, the 3D or depth camera 110 is oriented in a manner to obtain digital images of the inside of the charging-bucket 10. Accordingly, digital images may be obtained after respective layers of same or different types or classes of metallic scrap material are deposited into the charging-bucket, which enables a layer-by-layer analysis of the metallic scrap material deposited in the charging-bucket. The 3D or depth camera, for example, may include two (2) stereo vision monochrome cameras, a red-green-blue (RGB) camera, and an infrared spectrum projector. The 3D or depth camera may also include an inertial measurement unit (IMU) including a gyroscope and an accelerometer, which may assist in offsetting an undesirably vibration of the camera during use. One example 3D or depth camera includes Intel® RealSense™ Depth Camera D435. The 3D or depth camera, for instance, is configured to obtain digital images of the metallic scrap material, for example, in a layer-by-layer fashion upon deposition of each layer of metallic scrap material.

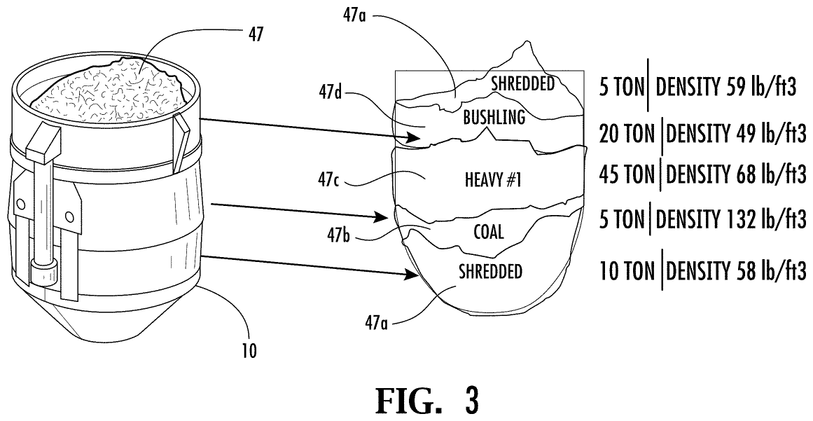

FIG. 3, for example, illustrates a charging-bucket 10 housing metallic scrap material 47 defined by a plurality of layers of different types or classes of metallic scrap material 47a, 47b, 47c, 47d in accordance with certain embodiments of the invention. As illustrated in FIG. 3, the methods and systems in accordance with certain embodiments of the invention may determine the volume of each respective layer of the metallic scrap material using, for example, stereo vision to define a depth image, in which one or more pixels of the depth image has been mapped or otherwise correlated to 3D coordinates of the metallic scrap material that may be used to determine the volume of the layer of metallic scrap material being analyzed, such as in a computer processor. The methods and systems in accordance with certain embodiments of the invention may also identify and/or classify the type or class of the each layer of the metallic scrap material on a layer-by-layer fashion based on at least a portion of at least one RGB digital image of each layer upon (or after) deposition of the respective layer of metallic scrap material, such as via a computer processor, and assign each identified layer of metallic scrap material an associated density and/or chemical composition of the identified type or class of metallic scrap material. In this regard, the respective volumes of each layer of metallic scrap material in combination with the respective assigned density of each layer of metallic scrap material may be used to determine the respective mass of each layer of metallic scrap material, such as illustrated in FIG. 3. In accordance with certain embodiments of the invention, the respective mass and/or the respective chemical composition of each layer of metallic scrap material may be used to determine an aggregate mass, chemical composition, and volume of the metallic scrap material loaded into the charging-bucket in a computer processor. In this regard, an actual batch profile for the contents within the charging-bucket may be determined in a computer processor, which may be integrated (e.g., directly wired or wirelessly connected) to a separate programmable logic control (PLC) associated with monitoring and/or controlling the operation of the EAF (e.g., positioning of the electrodes, controlling electrical current to the electrodes, etc.). As discussed throughout, the methods and systems according to certain embodiments of the invention may identify and classify the first type or class 47a and the second type or class 47b of the metallic scrap material via a machine learning model based on at least a portion of an RGB digital image taken by the 3D camera in use. Operation of the machine learning model may be conducted on a computer processor or a PLC associated with monitoring and/or controlling the operation of the EAF.

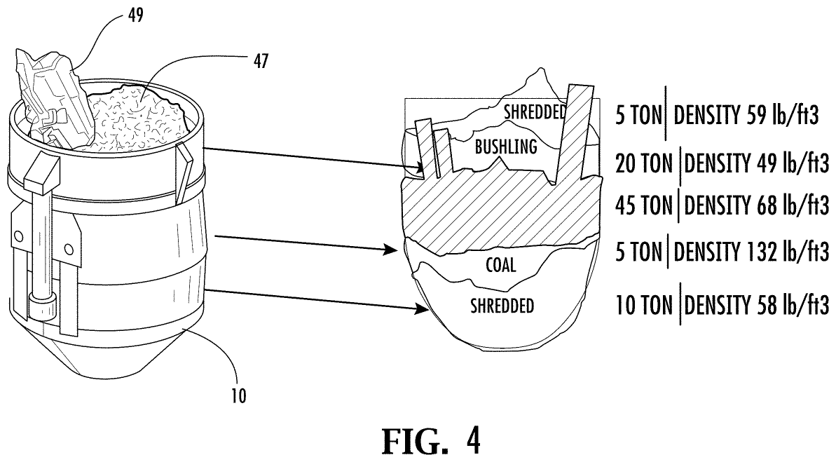

FIG. 4 illustrates a charging-bucket holding a plurality of layers of different types or classes of metallic scrap material including an oversized piece 49 of scrap material that may be detected and result in the triggering of an alarm in accordance with certain embodiments of the invention. In this regard, the oversized piece 49 of scrap material may be identified in a computer processor based on a depth image obtained by a 3D or depth camera as described and disclosed herein. As illustrated by FIG. 4, for instance, the oversized-piece of metallic scrap material may be associated with an individual volume or geometric configuration that exceeds a volume or size threshold, which may be fixed or varied as a function of the operating state of the EAF, by an available volume within the EAF.

In accordance with certain embodiments of the invention, one or more controllable lighting sources may be mounted proximate to the 3D or depth camera and configured to provide a fixed lighting intensity in real time. The fixed lighting intensity during operation may be helpful in the classification of the metallic scrap material as the machine learning model may include deep learning with one or more convolution layers that consider and/or weigh color scale(s) at one or more locations of the metallic scrap material. In this regard, the consistent or fixed lighting intensity reduces any potential errors associated with the quality of the RGB digital images used in identifying and/or classifying the metallic scrap material.

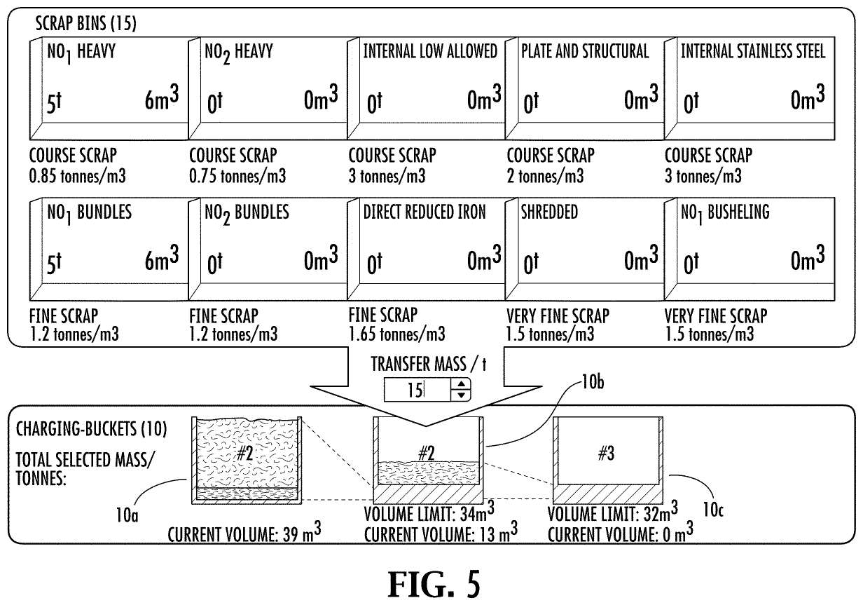

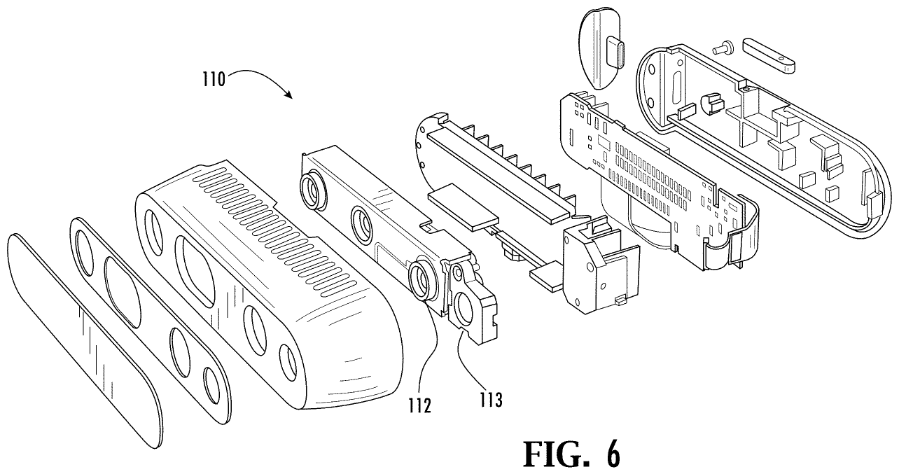

As noted above, the scheduled batch for charging into an EAF may comprise a plurality of charging-buckets. FIG. 5, for example, illustrates a three (3) bucket charge schedule accounting for a batch for charging into an EAF in accordance with certain embodiments of the invention. As generally illustrated by FIG. 5, each of the charging-buckets 10a, 10b, 10c may independently contain different volumes and different types or classes of metallic scrap material, which may be selected by an operator based on a planning schedule from one or more of the storage bins 15. In accordance with certain embodiments of the invention on overall batch profile may be determined in a computer processor based on the metallic scrap material loaded in any number of the charging-buckets containing metallic scrap material therein. In this regard, a layer-by-layer characterization of each of the charging buckets may have been determines as described and disclosed herein. The digital images of each respective layer of metallic scrap material, as noted above, may be obtained via a 3D or depth camera, such as illustrated by FIG. 6. FIG. 6 illustrates an example 3D or depth camera 110 including a pair of monochrome cameras 112 configured for stereo vision and an RGB camera 113.

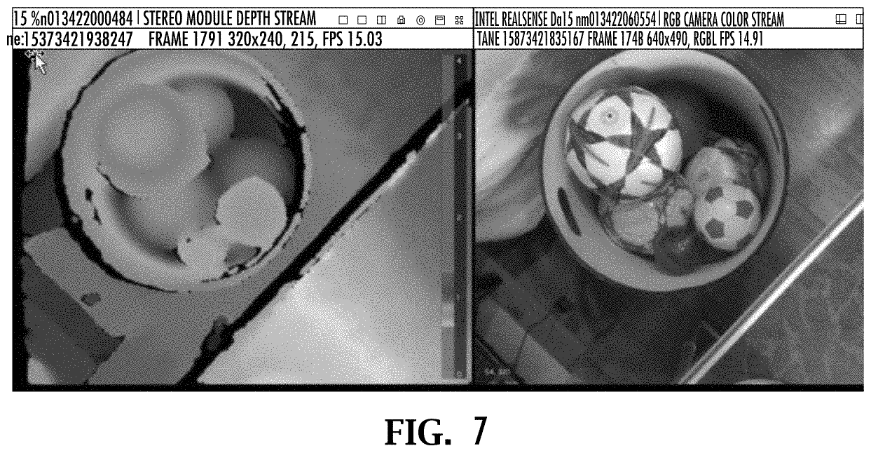

In one aspect, certain embodiments of the invention prove a method for determining a batch profile for a batchwise-charged EAF including one or more charging-buckets. In accordance with certain embodiments of the invention, the method may comprise the following steps: (i) obtaining respective RGB digital images of respective portions of respective layers (e.g., one or more separate layers stacked upon one another) of metallic scrap material deposited into a first charging-bucket; (ii) generating respective depth images via camera stereo vision of the respective portions of the respective layers of metallic scrap material in a computer processor, wherein one or more pixels of the respective depth images are correlated to respective 3D coordinates of the respective portions of respective layers of metallic scrap material in the computer processor; (iii) determining respective volumes of the respective portions of the respective layers of metallic scrap material in the computer processer based on at least a portion of the respective 3D coordinates of the respective portions of the respective layers of metallic scrap material; (v) identifying respective classifications of the respective portions of the respective layers of metallic scrap material from a group of known metallic scrap materials based on at least a respective portion of the respective RGB digital images via a machine learning model in the computer processor, and assigning a respective density to the respective portions of the respective layers of metallic scrap material; and (vi) determining a respective mass associated with respective portions of the respective layers of metallic scrap material based on (a) the respective volume of the respective portions of the respective layers of metallic scrap material and (b) the respective assigned density. FIG. 7, for example, shows a depth image generated by stereo vision on the left side and a corresponding RGB digital image on the right side.

As noted above, the method may comprise a step of assigning a respective chemical composition to the respective portions of the respective layers of metallic scrap material based on at least a portion of the respective RGB digital images via the machine learning model in the computer processor. Additionally or alternatively, the method may comprise determining an aggregate mass of metallic scrap material within the first charging-bucket, and/or an aggregate volume of metallic scrap material within the first charging-bucket, and/or an aggregate chemical composition of the metallic scrap material within the first charging-bucket in the computer processor. Additionally or alternatively, the method may further comprise determining an aggregate mass of metallic scrap material within a second charging-bucket, and/or an aggregate volume of metallic scrap material within the second charging-bucket, and/or an aggregate chemical composition of the metallic scrap material within the second charging-bucket in the computer processor. Additionally or alternatively, the method may further comprise determining an aggregate mass of metallic scrap material within a third charging-bucket, and/or an aggregate volume of metallic scrap material within the third charging-bucket, and/or an aggregate chemical composition of the metallic scrap material within the third charging-bucket. In accordance with certain embodiments of the invention, the method may comprise determining a multi-charging-bucket-aggregate mass of metallic scrap material within two or more charging-buckets, and/or a multi-charging-bucket-aggregate volume of metallic scrap material within two or more charging-buckets, and/or a multi-charging-bucket-aggregate chemical composition of the metallic scrap material within two or more charging-buckets in the computer processor. In this regard, a profile of the batch (whether one or a plurality of charging-buckets of metallic scrap material) may be determined and integrated with other control schemes associated with operation of the EAF.

In accordance with certain embodiments of the invention, for example, the respective portions of respective layers of metallic scrap material deposited into a first charging-bucket include a first portion of a metallic scrap material deposited into a first charging-bucket as first layer, and wherein the method comprises: (i) obtaining a RGB digital image of a first portion of a metallic scrap material deposited into a first charging-bucket as first layer; (ii) generating a first depth image via camera stereo vision of the first portion of the metallic scrap material in a computer processor, wherein one or more pixels of the first depth image are correlated to 3D coordinates of the first portion of the metallic scrap material in the computer processor; (iii) determining a first volume of the first portion of the metallic scrap material in the computer processer based on at least a portion of the 3D coordinates of the first portion of the metallic scrap material; (v) identifying a first classification of the first portion of metallic scrap material from a group of known metallic scrap materials based on at least a portion of a first RGB digital image via a machine learning model in the computer processor, and assigning a first density to the first portion of metallic scrap material; and (vi) determining the mass associated with the first portion of the metallic scrap material based on (a) the first volume of the first portion of the metallic scrap material and (b) the assigned first density. The method, in accordance with certain embodiments of the invention, may comprise assigning a first chemical composition of the first portion of the metallic scrap material based on at least a portion of the first RGB digital image via the machine learning model in the computer processor. Additionally, the respective portions of respective layers of metallic scrap material deposited into a first charging-bucket include a second portion of a metallic scrap material deposited on top of the first layer within the first charging-bucket to define a second layer, and wherein the second portion of metallic scrap material is different than the first portion of metallic scrap material, and wherein the method may comprise: (i) obtaining a second RGB digital image of a second portion of a metallic scrap material deposited on top of the first layer within the first charging-bucket to define a second layer, wherein the second portion of metallic scrap material is different than the first portion of metallic scrap material; (ii) generating a second depth image via camera stereo vision of the second portion of the metallic scrap material in the computer processor, wherein one or more pixels of the second depth image are correlated to 3D coordinates of the second portion of the metallic scrap material in the computer processor; (iii) determining a second volume of the second portion of the metallic scrap material in the computer processer based on at least a portion of the 3D coordinates of the second portion of the metallic scrap material; (v) identifying a second classification of the second portion of metallic scrap material from a group of known metallic scrap materials based on at least a portion of a second RGB digital image via the machine learning model in the computer processor, and assigning a second density to the second portion of metallic scrap material; and (vi) determining the mass associated with the second portion of the metallic scrap material based on (a) the second volume of the second portion of the metallic scrap material and (b) the assigned second density. In accordance with certain embodiments of the invention, the method may comprise assigning a second chemical composition of the second portion of the metallic scrap material based on at least a portion of the second RGB digital image via the machine learning model in the computer processor.

In accordance with certain embodiments of the invention, the method may optionally include a step of merging the respective depth images and the respective RGB digital image to generate respective 3D composite images of the respective portions of the respective layers of metallic scrap material in the computer processor and optionally displaying the respective 3D composite images onto a user display. Additionally or alternatively, the method may comprise a step of conducting a volume-calibration operation comprising mapping a plurality of pixels associated with a plurality of known locations of a calibration implement (e.g., inanimate object of known dimensions placed in an empty charging-bucket) to a 3D coordinate system, and generating a volume-calculating model in the computer processor based on the mapped pixels, and wherein the volume-calculating model is configured to determine the respective volume of the respective portions of the respective layers of metallic scrap material in the computer processer based on at least a portion of the respective 3D coordinates of the of the respective portions of the respective layers of metallic scrap material.

In accordance with certain embodiments of the invention, the first RGB image (for example) may be transmitted to the machine learning model for convergence on a solution, such as identification and/or classification of the metallic scrap material imaged (e.g., the first portion of metallic scrap material) from a group of known metallic scrap materials based on at least a portion of a first RGB image via a neural network in the computer processor. After the machine learning model converges onto a solution for the identification of the metallic scrap material imaged (e.g., NO₂ Heavy), a computer processor may assign, for example, a first density and/or a first chemical composition to the first portion of scrap material (e.g., NO₂ Heavy has a density of 0.75 kg/m³) and determine the mass and/or chemical composition associated with the first portion of the metallic scrap material based on (a) the first volume of the first portion of the metallic scrap material, and (b) the assigned first density and/or the assigned first chemical composition.

In accordance with certain embodiments of the invention, the machine learning model as disclosed and described herein may comprise one or more types of machine learning including, for example, neural networks (e.g., convolutional neural networks, recurrent neural networks, deep learning neural networks, natural language processing, etc.), transformers, support vector machines (SVM), and clusters (e.g., clustered machine learning). In this regard, for instance, the use of the term “machine learning model” throughout the present disclosure may include (i) a single type of machine learning model in accordance with certain embodiments of the invention (ii) a plurality of different types of machine learning models in accordance with certain other embodiments of the invention. For example only, a first type of machine learning model (e.g., a neural network) may be employed for the identification and classification of one or more types or classifications of metallic scrap material while a second type of machine learning model may be employed for the identification and/or classification of undesirable materials or potentially undesirable materials (e.g., oils or other liquids that are not desirable within the EAF, closed containers that may contain oils or other liquids that are not desirable within the EAF, etc.) intermixed with the metallic scrap material intended to be charged into the EAF. The first type of machine learning model, for example, may comprise a deep learning solution with a plurality of convolution layers and/or a plurality of pooling layers, and at least one fully-connected layer configured for the identification and/or classification of one or more types or classes of metallic scrap material. In this regard, for example, at least one of the convolution layers may capture the scrap type with a maximum score, which is chosen as the classification output for the input scrap image. In accordance with certain embodiments of the invention, a first convolution layer may consider and/or weigh identified straight edges, arcuate edges, colors, and/or color gradients across a surface. In accordance with certain embodiments of the invention, different layers may have different node layouts in which each node may have a respective weight. The respective weights may be calculated during a training phase and a model output may be customized for the different customer scrap types utilized in the EAF.

In accordance with certain embodiments, a scrap classification model was developed using machine learning technology. For example, an initial model may be selected for training, such as by backpropagation which works to feed classified data into the model and then measures the model's performance. The error rate is measured using a loss function. In this regard, for example, backpropagation works by using gradient descent to measure the rate of change of the loss function with respect to the weighting of each connection, and the gradient descent step is used to make sure the error rate for each connection is reduced as close to zero as possible to assure that network will converge on a solution. In accordance with certain embodiments of the invention, an initial algorithm or model configured for general image identification may be trained by selecting one or more of the following: selecting the percentage of images used for training and for validation (e.g., 70% for training and 30% for validation); applying different preprocess to the input images; setting training and validation thresholds; defining iteration per epoch; selecting the gradient threshold method; choosing the learning rate; and verifying the confusion matrix. Once the trained model satisfies all of the user specifications the model may be exported to a computer processor for use in image identification and/or classification in accordance with certain embodiments of the invention. For example, the algorithm or model may be exported as an Open Neural Network Exchange (ONNX) model. Open Neural Network Exchange (ONNX) is an open format to represent artificial intelligence models that is widely supported and can be found in many frameworks, tools, and hardware. In accordance with certain embodiments, the algorithm or model may be re-trained if an unacceptable number of non-solutions are reached during operation of certain methods as described and disclosed herein.

In another aspect, certain embodiments according to the invention provide a method of operating a batchwise-charged electric arc furnace (EAF) including one or more charging-buckets. The method may comprise determining an actual batch profile defined by metallic scrap material housed within one more charging-buckets. The step of determining the actual batch profile may comprise a step of (i) determining a respective mass associated with respective portions of the respective layers of metallic scrap material based on (a) the respective volume of the respective portions of the respective layers of metallic scrap material and (b) the respective assigned density as described and disclosed herein; and/or (ii) determining an aggregate mass of metallic scrap material within a one or more charging-buckets as described and disclosed herein, and/or an aggregate volume of metallic scrap material within the one or more charging-buckets as described and disclosed herein, and/or (iii) determining an aggregate chemical composition of the metallic scrap material within the one or more charging-buckets as described and disclosed herein. The method may further comprise comparing the actual batch profile with an operating state and/or an operating set point of the EAF in a computer processor and modifying an the operating state and/or the operating set point based on the actual batch profile.

In accordance with certain embodiments of the invention, the method may comprise modifying one or more operating states and/or one or more operating set points, such as adjusting the depth of an electrode that extends into the EAF to prevent a scrap cave in that might break the electrode. Additionally or alternatively, the method may comprise modifying one or more operating states and/or one or more operating set points, such as adjusting the power profile of the EAF to use a more conservative bore in approach, and/or the electrode water cooling profile. Additionally or alternatively, the computer processor may be configured to identify and/or trigger a first alarm when a piece of the metallic scrap material is identified as having a volume or three-dimensional size above a size threshold and/or an orientation extending outside of a predetermined working zone defined by a fixed volume of the EAF. In this regard, the size threshold may be based on a volume or size that may undesirably strike the electrodes in the EAF during operation. An operator, in such a scenario, will have an opportunity to remove the oversized piece of the metallic scrap material or alter the operating state of the EAF based on the knowledge of the existence of the oversized piece of metallic scrap material. Additionally or alternatively, the machine learning model in the computer processor may be configured to identify undesirable materials (e.g., oils or other liquids that are not desirable within the EAF) intermixed with the metallic scrap material and trigger a second alarm.

In another aspect, certain embodiments according to the invention provide a system for determining a batch profile for a batchwise-charged electric arc furnace (EAF) including one or more charging-buckets. The system may include a sensor fusion module including two monochrome cameras configured to provide stereo vision, a RGB camera, an infrared spectrum projector, and a first computer processor in operative communication with the two monochrome cameras, the RGB camera, and the infrared spectrum projector. The first computer processor may be configured to (a) generate respective depth images via stereo and correlate one or more pixels of the respective depth images to respective 3D coordinates of the respective portions of respective layers of metallic scrap material, and (c) determine respective volumes of the respective portions of the respective layers of metallic scrap material based on at least a portion of the respective 3D coordinates of the respective portions of the respective layers of metallic scrap material. The system may also include a scrap classifier module in operative communication with the sensor fusion module and comprising a machine learning model and a second computer processor. The second computer processor may be configured to (a) identify respective classifications of the respective portions of the respective layers of metallic scrap material from a group of known metallic scrap materials based on at least a respective portion of the respective RGB digital images received from the sensor fusion module, (b) assign a respective density to the respective portions of the respective layers of metallic scrap material, and (c) determine a respective mass associated with respective portions of the respective layers of metallic scrap material based on (a) the respective volume of the respective portions of the respective layers of metallic scrap material and (b) the respective assigned density.

In yet another aspect, certain embodiments according to the invention provide an electric arc furnace (EAF) system. The system may include an EAF including a furnace body defining an interior portion and a set of electrodes extending into the interior portion. The system may also include one or more charging-buckets. In accordance with certain embodiments of the invention, the system may include a sensor fusion module mounted above and proximate to the one or more charging-buckets, the sensor fusion module including two monochrome cameras configured to provide stereo vision, a RGB camera, an infrared spectrum projector, and a first computer processor in operative communication with the two monochrome cameras, the RGB camera, and the infrared spectrum projector. The first computer processor may be configured to (a) generate respective depth images via stereo and correlate one or more pixels of the respective depth images to respective 3D coordinates of the respective portions of respective layers of metallic scrap material, and (c) determine respective volumes of the respective portions of the respective layers of metallic scrap material based on at least a portion of the respective 3D coordinates of the respective portions of the respective layers of metallic scrap material. The system may also comprise a scrap classifier module in operative communication with the sensor fusion module and comprising a machine learning model and a second computer processor configured to (a) identify respective classifications of the respective portions of the respective layers of metallic scrap material from a group of known metallic scrap materials based on at least a respective portion of the respective RGB digital images received from the sensor fusion module, (b) assign a respective density to the respective portions of the respective layers of metallic scrap material, and (c) determine a respective mass associated with respective portions of the respective layers of metallic scrap material based on (a) the respective volume of the respective portions of the respective layers of metallic scrap material and (b) the respective assigned density.

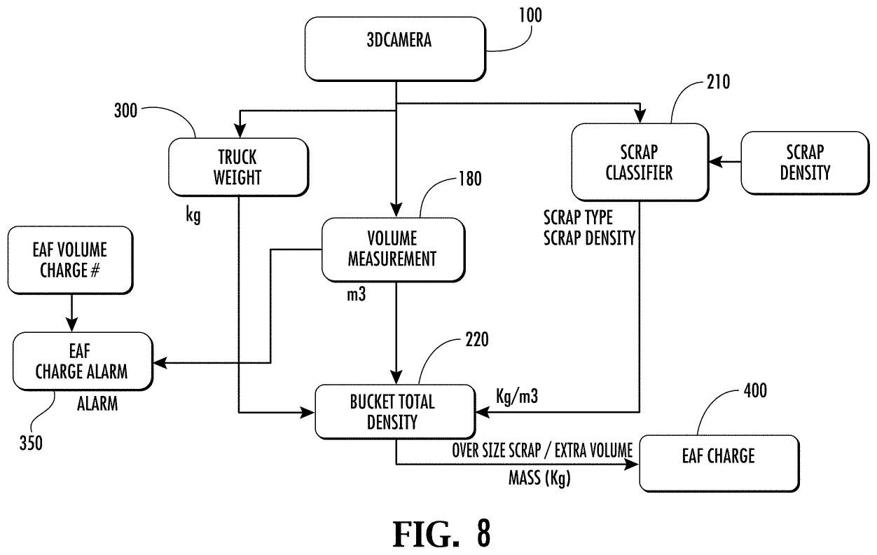

FIG. 8 illustrates a system functionality flow chart in accordance with certain embodiments of the invention. As schematically illustrated in FIG. 8, a 3D camera 110 (as part of a sensor fusion module) obtains digital images that may be processed or analyzed in (i) a volume measurement module 180 that determined volume of metallic scrap material in a computer processor based on a depth image and (ii) a scrap classifier 210 including the machine learning model fitted to identify and/or classify the metallic scrap material based on a RGB digital image of the metallic scrap material as described and disclosed herein. Once the metallic scrap material has been classified, the associated density and/or chemical composition is assigned to the metallic scrap material. The determined volume and the assigned density may be utilized in a charging-bucket total module that determines a layer-by-layer mass and/or an aggregate mass of the metallic scrap material within the charging-bucket that may define the EAF batch charge 400. FIG. 8 also illustrates that certain embodiments may also employ data received from a load cell 300 (i.e., identified as truck weight on FIG. 8) located under the charging-bucket. In this regard, the determined mass and volume via the volume measurement module 180 and the scrap classifier 180 may be compared to the weight/mass measured by the load cell 180 in a computer processor. In this regard, a discrepancy between the determined mass and the measured mass from the load cell may be trigger an alarm that non-metallic scrap material may also be present in the charging-bucket, such as lime or carbon which falls to the bottom of the charging-bucket in a manner that increases the weight and/or mass held within the charging-bucket but does not significantly impact the determined volume based on the respective depth images. In accordance with certain embodiments of the invention, the operating conditions may be revised based on the identification of the presence of the lime or carbon present within the batch to be charged to the EAF. Moreover, the difference between the measured weight/mass via the load cell and that of the determined mass of the batch may estimate the mass of the lime and/or carbon present in the batch, which may be used to alter a proposed operation of the EAF. As also illustrated in FIG. 8, a determined volume of metallic scrap material exceeding a threshold may trigger an alarm 350 as noted above.

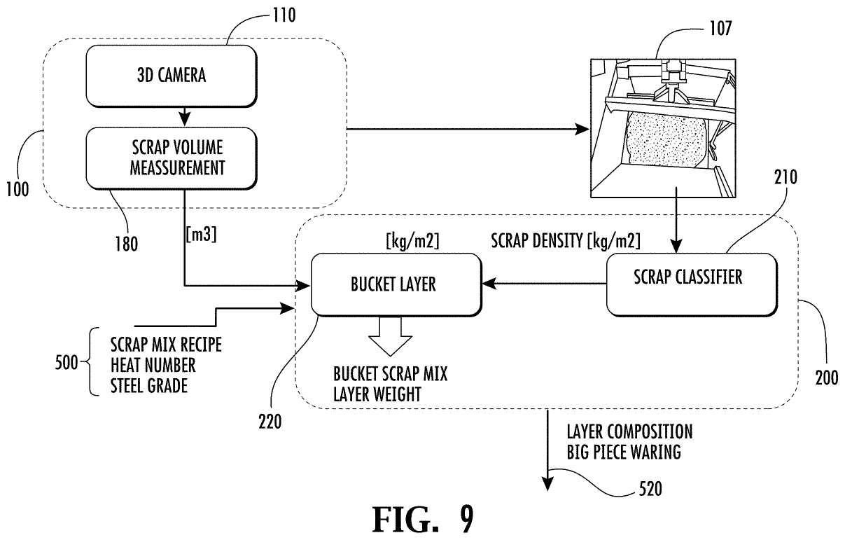

FIG. 9 illustrates a schematic of a system for operating an EAF system in accordance with certain embodiments of the invention that includes a sensor fusion module 100 including a computer processor 120 in operative communication with a metallic scrap volume measurement module 180. The sensor fusion module 100 may deliver the real time volume value of the imaged metallic scrap material to a PLC 200 (or other computer processer) associated with controlling the operation of the EAF. The sensor fusion module 100 also sends an RGB digital image 107 of the metallic scrap material to a scrap classifier module 210 for identification of the type or class of the metallic scrap material via a machine learning model and assign a density and/or chemical composition to the metallic scrap material. The assigned density and/or the assigned chemical composition, and the determined volume of the metallic scrap material may be input to a bucket layer module 220 that outputs the layer-by-layer mass and/or the aggregate mass of the metallic scrap material. The PLC 200 may also receive a variety of scheduled batch targets 500 for the batch charge. The PLC may compare the scheduled batch targets 500 for the batch charge with determined profile of the metallic scrap material of the batch, and adjust operating conditions or parameters of the EAF for processing of the batch.

These and other modifications and variations to embodiments of the invention may be practiced by those of ordinary skill in the art without departing from the spirit and scope of the invention, which is more particularly set forth in the appended claims. In addition, it should be understood that aspects of the various embodiments may be interchanged in whole or in part. Furthermore, those of ordinary skill in the art will appreciate that the foregoing description is by way of example only, and it is not intended to limit the invention as further described in such appended claims. Therefore, the spirit and scope of the appended claims should not be limited to the exemplary description of the versions contained herein.

That which is claimed:

1. A method for determining a batch profile for a batchwise-charged electric arc furnace (EAF) including one or more charging-buckets, comprising:
(i) obtaining respective red-green-blue (RGB) digital images of respective portions of respective layers of metallic scrap material deposited into a first charging-bucket;
(ii) generating respective depth images via camera stereo vision of the respective portions of the respective layers of metallic scrap material in a computer processor, wherein one or more pixels of the respective depth images are correlated to respective 3D coordinates of the respective portions of respective layers of metallic scrap material in the computer processor;
(iii) determining respective volumes of the respective portions of the respective layers of metallic scrap material in the computer processer based on at least a portion of the respective 3D coordinates of the respective portions of the respective layers of metallic scrap material;
(v) identifying respective classifications of the respective portions of the respective layers of metallic scrap material from a group of known metallic scrap materials based on at least a respective portion of the respective RGB digital images via a machine learning model in the computer processor, and assigning a respective density to the respective portions of the respective layers of metallic scrap material; and
(vi) determining a respective mass associated with respective portions of the respective layers of metallic scrap material based on (a) the respective volume of the respective portions of the respective layers of metallic scrap material and (b) the respective assigned density.

2. The method of claim 1, further comprising assigning a respective chemical composition to the respective portions of the respective layers of metallic scrap material based on at least a portion of the respective RGB digital images via the machine learning model in the computer processor.

3. The method of claim 2, further comprising determining an aggregate mass of metallic scrap material within the first charging-bucket, and/or an aggregate volume of metallic scrap material within the first charging-bucket, and/or an aggregate chemical composition of the metallic scrap material within the first charging-bucket in the computer processor.

4. The method of claim 3, further comprising determining an aggregate mass of metallic scrap material within a second charging-bucket, and/or an aggregate volume of metallic scrap material within the second charging-bucket, and/or an aggregate chemical composition of the metallic scrap material within the second charging-bucket in the computer processor.

5. The method of claim 4, further comprising determining an aggregate mass of metallic scrap material within a third charging-bucket, and/or an aggregate volume of metallic scrap material within the third charging-bucket, and/or an aggregate chemical composition of the metallic scrap material within the third charging-bucket.

6. The method of claim 3, further comprising determining a multi-charging-bucket-aggregate mass of metallic scrap material within two or more charging-buckets, and/or a multi-charging-bucket-aggregate volume of metallic scrap material within two or more charging-buckets, and/or a multi-charging-bucket-aggregate chemical composition of the metallic scrap material within two or more charging-buckets in the computer processor.

7. The method of claim 1, wherein the respective portions of respective layers of metallic scrap material deposited into a first charging-bucket include a first portion of a metallic scrap material deposited into a first charging-bucket as first layer, and wherein the method comprises:
(i) obtaining a RGB digital image of a first portion of a metallic scrap material deposited into a first charging-bucket as first layer;
(ii) generating a first depth image via camera stereo vision of the first portion of the metallic scrap material in a computer processor, wherein one or more pixels of the first depth image are correlated to 3D coordinates of the first portion of the metallic scrap material in the computer processor;
(iii) determining a first volume of the first portion of the metallic scrap material in the computer processer based on at least a portion of the 3D coordinates of the first portion of the metallic scrap material;
(v) identifying a first classification of the first portion of metallic scrap material from a group of known metallic scrap materials based on at least a portion of a first RGB digital image via a machine learning model in the computer processor, and assigning a first density to the first portion of metallic scrap material; and
(vi) determining the mass associated with the first portion of the metallic scrap material based on (a) the first volume of the first portion of the metallic scrap material and (b) the assigned first density.

8. The method of claim 7, further comprising assigning a first chemical composition of the first portion of the metallic scrap material based on at least a portion of the first RGB digital image via the machine learning model in the computer processor.

9. The method of claim 1, wherein the respective portions of respective layers of metallic scrap material deposited into a first charging-bucket include a second portion of a metallic scrap material deposited on top of the first layer within the first charging-bucket to define a second layer, and wherein the second portion of metallic scrap material is different than the first portion of metallic scrap material, and wherein the method comprises:
(i) obtaining a second RGB digital image of a second portion of a metallic scrap material deposited on top of the first layer within the first charging-bucket to define a second layer, wherein the second portion of metallic scrap material is different than the first portion of metallic scrap material;
(ii) generating a second depth image via camera stereo vision of the second portion of the metallic scrap material in the computer processor, wherein one or more pixels of the second depth image are correlated to 3D coordinates of the second portion of the metallic scrap material in the computer processor;
(iii) determining a second volume of the second portion of the metallic scrap material in the computer processer based on at least a portion of the 3D coordinates of the second portion of the metallic scrap material;
(v) identifying a second classification of the second portion of metallic scrap material from a group of known metallic scrap materials based on at least a portion of a second RGB digital image via the machine learning model in the computer processor, and assigning a second density to the second portion of metallic scrap material; and
(vi) determining the mass associated with the second portion of the metallic scrap material based on (a) the second volume of the second portion of the metallic scrap material and (b) the assigned second density.

10. The method of claim 9, further comprising assigning a second chemical composition of the second portion of the metallic scrap material based on at least a portion of the second RGB digital image via the machine learning model in the computer processor.

11. The method of claim 1, further comprising a step of conducting a volume-calibration operation comprising mapping a plurality of pixels associated with a plurality of known locations of a calibration implement placed in an empty charging-bucket to a 3D coordinate system, and generating a volume-calculating model in the computer processor based on the mapped pixels, and wherein the volume-calculating model is configured to determine the respective volume of the respective portions of the respective layers of metallic scrap material in the computer processer based on at least a portion of the respective 3D coordinates of the of the respective portions of the respective layers of metallic scrap material.

12. The method of claim 1, further comprising a step of merging the respective depth images and the respective RGB digital image to generate respective 3D composite images of the respective portions of the respective layers of metallic scrap material in the computer processor and optionally displaying the respective 3D composite images onto a user display.

13. The method of claim 1, wherein the machine learning model includes deep learning with a plurality of convolution layers and/or a plurality of pooling layers, and at least one fully-connected layer, wherein at least one of the convolution layers captures the scrap type with a maximum score, which is chosen as the classification output for the input scrap image.

14. The method of claim 1, wherein a classification model executes an algorithm developed by machine learning.

15. A method of operating a batchwise-charged electric arc furnace (EAF) including one or more charging-buckets, comprising:
(i) determining an actual batch profile defined by metallic scrap material housed within one more charging-buckets comprising a step of determining a respective mass associated with respective portions of the respective layers of metallic scrap material based on (a) the respective volume of the respective portions of the respective layers of metallic scrap material and (b) the respective assigned density in accordance with claim 1; and/or determining an aggregate mass of metallic scrap material within a one or more charging-buckets, and/or an aggregate volume of metallic scrap material within the one or more charging-buckets in accordance with claim 3, and/or an aggregate chemical composition of the metallic scrap material within the one or more charging-buckets in accordance with claim 3;
(ii) comparing the actual batch profile with an operating state and/or an operating set point of the EAF in a computer processor;
(iii) modifying an the operating state and/or the operating set point.

16. The method of claim 15, wherein modifying an the operating state and/or the operating set point comprising adjusting the depth of an electrode that extends into the EAF.

17. The method of claim 15, wherein the computer processor is configured to identify and/or trigger a first alarm when a piece of the metallic scrap material is identified as having a volume or three-dimensional size above a size threshold and/or an orientation extending outside of a predetermined working zone defined by a fixed volume of the EAF.

18. The method of claim 15, wherein the machine learning model in the computer processor is configured to identify undesirable materials intermixed with the metallic scrap material and trigger a second alarm.

19. A system for determining a batch profile for a batchwise-charged electric arc furnace (EAF) including one or more charging-buckets, comprising:
(i) a sensor fusion module including two monochrome cameras configured to provide stereo vision, a RGB camera, an infrared spectrum projector, and a first computer processor in operative communication with the two monochrome cameras, the RGB camera, and the infrared spectrum projector; wherein the first computer processor is configured to (a) generate respective depth images via stereo and correlate one or more pixels of the respective depth images to respective 3D coordinates of the respective portions of respective layers of metallic scrap material, and (c) determine respective volumes of the respective portions of the respective layers of metallic scrap material based on at least a portion of the respective 3D coordinates of the respective portions of the respective layers of metallic scrap material;
(ii) a scrap classifier module in operative communication with the sensor fusion module and comprising a machine learning model and a second computer processor configured to (a) identify respective classifications of the respective portions of the respective layers of metallic scrap material from a group of known metallic scrap materials based on at least a respective portion of the respective RGB digital images received from the sensor fusion module, (b) assign a respective density to the respective portions of the respective layers of metallic scrap material, and (c) determine a respective mass associated with respective portions of the respective layers of metallic scrap material based on (a) the respective volume of the respective portions of the respective layers of metallic scrap material and (b) the respective assigned density.

20. An electric arc furnace (EAF) system, comprising:
(i) an EAF including a furnace body defining an interior portion and a set of electrodes extending into the interior portion;
(ii) one or more charging-buckets;
(iii) a sensor fusion module mounted above and proximate to the one or more charging-buckets, the sensor fusion module including two monochrome cameras configured to provide stereo vision, a RGB camera, an infrared spectrum projector, and a first computer processor in operative communication with the two monochrome cameras, the RGB camera, and the infrared spectrum projector; wherein the first computer processor is configured to (a) generate respective depth images via stereo and correlate one or more pixels of the respective depth images to respective 3D coordinates of the respective portions of respective layers of metallic scrap material, and (c) determine respective volumes of the respective portions of the respective layers of metallic scrap material based on at least a portion of the respective 3D coordinates of the respective portions of the respective layers of metallic scrap material;
(ii) a scrap classifier module in operative communication with the sensor fusion module and comprising a machine learning model and a second computer processor configured to (a) identify respective classifications of the respective portions of the respective layers of metallic scrap material from a group of known metallic scrap materials based on at least a respective portion of the respective RGB digital images received from the sensor fusion module, (b) assign a respective density to the respective portions of the respective layers of metallic scrap material, and (c) determine a respective mass associated with respective portions of the respective layers of metallic scrap material based on (a) the respective volume of the respective portions of the respective layers of metallic scrap material and (b) the respective assigned density.
